(19) United States
(12) Patent Application Publication
(10) Pub. No.: US 2003/0113671 A1
(43) Pub. Date: Jun. 19, 2003

(54) Manufacturing method for optical disc master

(76) Inventor: Takashi Ohgo, Kanagawa-ken (JP)

Correspondence Address: NATH & ASSOCIATES, PLLC, Sixth Floor, 1030 15th Street, N.W., Washington, DC, 20005, US

(21) Appl. No.: 10/318,184

(22) Filed: Dec. 13, 2002

(30) Foreign Application Priority Data
Dec. 17, 2001 (JP) P2001-382461
Jul. 16, 2002 (JP) P2002-207556

(51) Int. Cl. G03C 5/00

(52) U.S. Cl. 430/321; 430/945; 430/320

(57) ABSTRACT

This invention provides a manufacturing method for an optical disc master, in which a photoresist layer is formed on a substrate, and then a laser beam having a wavelength of 200 to 300 nm is exposed to the photoresist layer to form thereon a latent image corresponding to an information signal, and then the latent image is developed with an alkaline aqueous solution to form a convex-concave pattern. Particularly, in the manufacturing method for the optical disc master, a value obtained by multiplying a value A with a film thickness is set in a range of 0.02 to 0.06. The value A is a change amount of a light transmittance per unit depth under a wavelength of light for exposure of the photoresist layer. Further, in the manufacturing method, a value obtained by multiplying a value B with the film thickness is set to be equal to or less than 0.3. The value B is an optical density of a base resin and a photoproduct per unit depth under the wavelength of light for exposure of the photoresist layer. Consequently, an optical disc master which enables manufacturing of an optical disc to be capable of meeting a demand for high density and large capacity.

### BACKGROUND OF THE INVENTION

1. Field of the Invention

The present invention relates to a manufacturing method for an optical disc master.

2. Description of Related Art

Generally, the optical disc has been widely used as a ROM type disc such as CD, LD, DVD-video, an additionally write-once disc such as CD-R, DVD-R and rewritable disc such as CD-RW, DVD-RAM and DVD-RW.

FIGS. 1A to 1H and FIGS. 2A to 2C are diagrams for explaining schematically a conventional manufacturing process for the optical disc.

First, photoresist layer 17 is formed by spin-coating method or the like on a glass substrate 16 whose surface is ground and washed so as to produce a blank master (see FIG. 1A).

Next, laser beam 18 from, an Ar, Kr, He—Cd laser projection unit is focused by an objective lens 19 and its minute spot is projected onto the aforementioned photoresist layer 17 formed on the glass substrate 16. At this time, by turning ON/OFF the laser beam 18 or emitting the laser beam continuously while rotating the glass substrate 16 or moving it horizontally at a constant speed, such a latent image 20 as a pit or groove is formed for example in the form of a spiral (see FIG. 1B).

Then, by developing the photoresist layer 17 with alkaline solution, an optical disc mater 32 in which a pattern 21 of the pit or groove is formed is produced (see FIG. 1C).

Conductive film 22 such as nickel is formed on the surface of the optical disc master 32 produced in the above described way by spattering or electroless plating (see FIG. 1D).

By supplying this master with current in nickel sulfamate solution, with this conductive film 22 as a cathode and nickel disposed at an anode, nickel film 23 is deposited thickly on the optical disc master 32 (see FIG. 1E).

Then, by separating this deposited nickel layer 23 from the optical disc master 32, a metallic master containing a signal pattern, namely, a stamper 24 is produced (see FIG. 1F). The manufacturing process for the optical disc master has been described above.

Next, mass-production of the optical disc is carried out through disc production process using the stamper 24. After the stamper 24 is processed in its internal and external diameters and post-treatment such as grinding of the rear surface is carried out, it is built into a mold installed on a molding machine. As for the molding method, a mold substrate 25 of a male mold is produced with the stamper 24 as a female mold using synthetic resins such as an acrylic resin, polycarbonate resin having a light transparency by compression method, injection method, photo-polymer (2P) method or the like. Consequently, a convex-concave pattern corresponding to a convex-concave pattern in the stamper 24 is transferred, so that a concave portion 26 corresponding to a convex portion in the stamper 24 based on information signal is formed in the mold substrate 25 (see FIG. 1G and FIG. 1H).

The thickness of this mold substrate 25 varies depending on the kind of the optical disc, and thus, for example, it is classified to three types which will be described below. Upon manufacturing of such a disc as CD-ROM, CD-R, CD-RW, the thickness H1 of the mold substrate 25 is set to about 1.2 mm as shown in FIG. 2A. In a next film forming process, aluminum or the like is applied to the main surface of the mold substrate 25 having the concave portions 26 so as to form reflective layer 27 or phase changing material is applied so as to form a recording layer 27. In the meantime, as its film forming method, vapor deposition or spattering is used.

Next, to protect the aforementioned reflective layer and the recording layer 27, an acrylic UV curable resin or the like is applied by a spraying method, roll coating method or spin coating method and is hardened to form a protective layer 28.

Finally, a label portion 29 is formed on the protective film 28 with UV curable ink or the like and then, an optical disc is completed.

In case of manufacturing such a disc as DVD-video, DVD-R, DVD-RAM, DVD-RW, the thickness H2 of the mold substrate 25 is set to about 0.6 mm as shown in FIG. 2B and after the reflective layer and recording layer 27 are formed in the same way as described above, two same substrates 25 are bonded together through an adhesive agent 30 so as to complete an optical disc.

Further, in case of manufacturing a next-generation high-density optical disc, the thickness H3 of the mold substrate 25 is set to about 1.1 mm as shown in FIG. 2C and after the reflective layer and the recording layer 27 are formed in the same way, a transparent plastic sheet 31 having a thickness of about 0.1 mm is bonded with an adhesive agent 32 so as to complete an optical disc or after the reflective layer and the recording layer 27 are formed, a light transparent layer 33 having a thickness of about 0.1 mm is formed with UV curable resin or the like so as to complete an optical disc. In this case, laser beam is emitted from the side of the sheet 31 or light transparent layer 33 so as to read signals.

The capacity of those optical discs for data to be recorded is determined depending on how high density the pit or groove can be recorded. That is, the capacity of an optical disc for information to be recorded is determined depending on how a minute convex-concave pattern, which forms a latent image by irradiating the photoresist layer with laser beam or a pit or groove by cutting, can be formed.

For example, as for the DVD-ROM which is a read-only digital video disc, a pit string whose minimum pit length is 0.4 μm and track pitch is 0.74 μm is formed spirally on its stamper and a single side of a mold substrate of 12 cm in diameter produced with this stamper as a mold is supplied with information capacity of 4.7 GB.

For this DVD-ROM cutting, for example, Kr (ion) laser beam having wavelength of 413 nm is employed. Generally, the minimum pit length P which can be formed in this case can be obtained in the following expression (1).

P=K(NA/λ) (1)

where λ indicates the wavelength of laser beam, NA indicates a numerical aperture of an objective lens, and K indicates a process factor value (which depends on mainly the characteristic of photoresist and is usually 0.8 to 0.9).

Therefore, in case of the DVD-ROM, if 413 nm, 0.9 and 0.9 are substituted for λ, NA and K respectively in the expression (1), the minimum pit length P is 0.4 μm.

With recent rapid development of information communication and image processing technology, the optical disc has been demanded to have further increased capacity. For example, if on an extension of the DVD-ROM, it is intended to provide a single side of an optical disc of 12 cm in diameter with its information capacity of 15 GB, the minimum pit length and track pitch need to be minutely shorted up to 0.22 μm and 0.41 μm respectively.

To form such high-density pits, the wavelength of laser beam is required to be shorter and the numerical aperture NA of an objective lens is required to be higher as evident from the aforementioned expression (1). However, the numerical aperture NA of the objective lens has substantially reached its limit of 0.9 from the viewpoints of lens design/production accuracy. Therefore, the laser beam absolutely needs to be shorter in its wavelength from now on. For example, when deep UV laser beam having the wavelength of 250 nm is employed, if 0.8 is substituted for K in the expression (1), the minimum pit length P of 0.23 μm is obtained. Therefore, if deep UV laser cutting is carried out on a photoresist layer having sensitivity and resolution equal to conventional one, an optical disc having information capacity of about 15 GB can be realized.

However, photoresist generally used since before, for example, novolac-based resist, has been adjusted to be optimized in its molecular design for an exposure system employing g-line of 436 nm in wavelength or i-line of 365 nm in wavelength for semiconductor photo-lithography, so that the same photoresist has such a characteristic that its light absorption increases rapidly under the wavelength of less than 300 nm.

For the reason, if this novolac-based photoresist is cut with deep UV laser beam, contrast value (γ value) which determines resolution is deteriorated by strong light absorption in resist, so that a pit having a poorly cut edge is formed. Further because the sensitivity of resist to deep UV laser beam drops for the same reason, productivity of cutting is reduced remarkably.

To solve such a problem, methods for raising the transparency of the photoresist in a deep UV beam region have been proposed (for example, Japanese Patent Application Laid-Open No.H11-102541/1999). However, this method has such a problem that the surface roughness of a non-exposed area (land area), which is not exposed to laser beam, becomes increased. That is, the novolac-based photoresist is composed of a naphthoquinone base photoactive compound, which is insoluble to alkaline, novolac resin which is soluble to alkaline, and organic solvent. Then, to raise transparency of the photoresist, the concentration of alkaline-insoluble photoactive compound needs to be reduced. Consequently, solubility of entire photoresist to alkaline is increased, so that the solubility of the not-exposed area is increased, thereby increasing the surface roughness as described above. The smoothness of the non-exposed area affects the CN ratio of a signal and therefore, the surface roughness must be as small as possible.

Thus, as a method for reducing the surface roughness of the not-exposed area, such technology of prolonging developing time while lowering the developer concentration has been proposed as disclosed in for example, Japanese Patent Application Laid-Open No.H8-235645/1996 and Japanese Patent Application Laid-Open No.H11-102540/1999.

However, in case of exposure using deep UV laser beam, the laser beam power needs to be increased in order to develop with a low-concentration developer because the sensitivity of the photoresist is not enough as described previously. Then, if the power is increased, there occurs such a new problem that the photoresist layer is deformed by heat generated by strong light absorption in the photoresist so that the pit configuration or groove configuration is deformed.

To avoid this problem, the sensitivity of the photoresist needs to be increased. However, if the concentration of the photoactive compound is lowered to increase the sensitivity, such a problem that the surface roughness is increased occurs as described above.

Thus, in cutting with deep UV laser beam, it has been quite difficult to apply a conventional resist as it is.

### SUMMARY OF THE INVENTION

The present invention has been accomplished to solve such problems and an object of the invention is to provide a manufacturing method for an optical disc master which enables manufacturing of an optical disc to be capable of meeting a demand for high density and large capacity.

As a result of considering the above-described problem, this inventor has found that the optical density and thickness of the photoresist layer affect the cutting characteristic largely and reached a first aspect of the present invention.

To achieve the above object, according to the first aspect of the present invention, there is provided a manufacturing method for optical disc master, in which a photoresist layer is formed on a substrate, and then a laser beam having a wavelength of 200 to 300 nm is exposed to the photoresist layer to form thereon a latent image corresponding to an information signal, and then the latent image is developed with an alkaline aqueous solution to form a convex-concave pattern, the method comprising the steps of: setting a value obtained by multiplying a value A with a film thickness in a range of 0.02 to 0.06, the value A being a change amount of a light transmittance per unit depth under a wavelength of light for exposure of the photoresist layer; and setting a value obtained by multiplying a value B with the film thickness to be equal to or less than 0.3, the value B being an optical concentration of a base resin and a photoproduct per unit depth under the wavelength of light for exposure of the photoresist layer.

Further, this inventor has found that there exists a close relation between the surface roughness of a non-exposed area and the developing condition and reached a second aspect of the present invention.

That is, to achieve the above-described object, according to the second aspect of the present invention, there is provided a manufacturing method for optical disc master, in which a photoresist layer is formed on a substrate, and then a laser beam having a wavelength of 200 to 300 nm is exposed to the photoresist layer to form thereon a latent image corresponding to an information signal, and then the latent image is developed with an alkaline aqueous solution to form a convex-concave pattern, the method comprising the steps of: setting a normality of the alkaline aqueous solution in a range of 0.2 to 0.35N; setting a developing time in a range of 10 to 60 seconds; and selecting an inorganic alkaline aqueous solution as the alkaline aqueous solution.

The nature, principle and utility of the invention will become more apparent from the following detailed description when read in conjunction with the accompanying drawings.

### BRIEF DESCRIPTION OF THE DRAWINGS

In the accompanying drawings:

FIGS. 1A to 1H are schematic process diagrams for explaining front half of a conventional manufacturing process for the optical disc;

FIGS. 2A to 2C are schematic process diagrams for explaining latter half of a conventional manufacturing process for the optical disc;

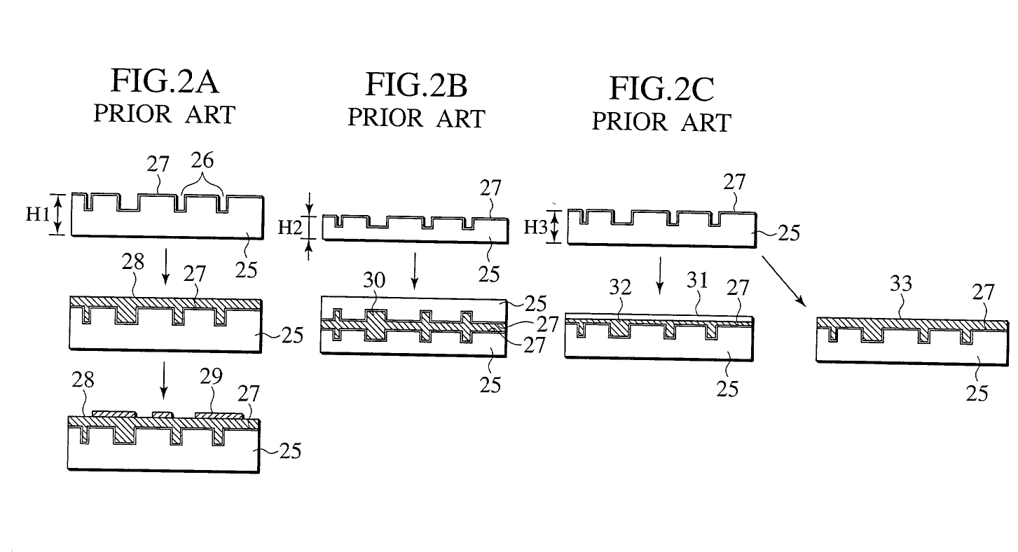

FIGS. 3A to 3G are process diagrams for explaining a first aspect of the manufacturing method for an optical disc master of the present invention;

FIG. 4 is a diagram showing an example of wavelength dependency of transmittance of a photoresist layer before and after exposure;

FIGS. 5A to 5C are diagrams showing a result of a case where the normality of developer and developing time are changed while inorganic alkaline developer is used;

FIGS. 6A to 6C are diagrams showing a result of a case where the normality of developer and developing time are changed while organic alkaline developer is used; and

FIGS. 7A to 7C are diagrams showing the relation between the normality of inorganic alkaline developer and surface roughness.

### DESCRIPTION OF THE PREFERRED EMBODIMENTS

Hereinafter, a preferred embodiment of the manufacturing method for the optical disc master of the present invention will be described in detail with reference to the accompanying drawings.

First, a first aspect of the present invention will be described.

This first aspect of the present invention has been reached by finding out that the optical density and thickness of the photoresist layer affect cutting characteristic largely.

According to the first aspect of the present invention, a photoresist layer is formed on a substrate and the photoresist layer is exposed to laser beam of 200 to 300 nm in wavelength so as to form a latent image corresponding to an information signal. The aforementioned latent image is developed with alkaline aqueous solution so as to form a convex-concave pattern. Further, according to the manufacturing method for the optical disc master, a numerical value obtained by multiplying value A, which is a change amount of light transmittance per unit depth of the photoresist layer, with the film thickness is in a range of 0.02 to 0.06 and a numerical value obtained by multiplying value B, which is an optical density of base resin and photoproduct per unit depth of the photoresist layer, with the film thickness is equal to or less than 0.3 (except zero).

Here, the value A is a change amount of light transmittance per unit depth of the photoresist layer and expressed in the following expression (2).

A=(1/d)1n[T(^{∞})/T(0)] (2)

where T(0) indicates a photoresist initial light transmittance, T(^{∞}) indicates a transmittance at the time when photoactive compound is decomposed completely, and d indicates a resist film thickness.

Further, the value B is an optical density of base resin and photoproduct per unit depth of the photoresist layer as described above, and expressed in the following expression (3).

B=−(1/d)1nT(^{∞}) (3)

If a value obtained by multiplying the aforementioned value A with a film thickness is less than 0.02, optical contrast at the time of exposure is low and dissolution contrast is also low and therefore, resolution is deteriorated.

On the other hand, if the value obtained by multiplying the value A with a film thickness exceeds 0.06, sensitivity drops remarkably thereby deteriorating productivity.

If laser beam power is raised so as to compensate for reduction of sensitivity, heat is generated due to internal absorption of photoresist so that the photoresist layer is deformed by heat.

If the value obtained by multiplying the value B with a film thickness exceeds 0.3, the optical density of base resin and photoproduct increases, thereby leading to reduction of resolution. In short, if any one of the value obtained by multiplying the value A expressed by the expression (2) with the film thickness and the value obtained by multiplying the value B expressed by the expression (3) with the film thickness does not satisfy the aforementioned relation, the CN ratio of the optical disc master is not improved, and consequently, no high-density optical disc having little noise upon reproduction can be obtained.

A photoresist used for the manufacturing method for the optical disc master of the first aspect of the invention contain base resin and photoactive compound.

Although for example, an alkaline soluble novolac resin is used preferably as this base resin, it is permissible to employ an alkaline soluble polyhydroxy styrene resin. As the photoactive compound contained together with the base resin, for example, o-quinone diazide, naphthoquinone diazide and the like can be employed.

The mixing ratio between the aforementioned base resin and photoactive compound cannot be determined uniformly because it changes depending on the kinds of the base resin, photoactive compound or combination thereof. However, for example in case of photoresist composed of combination of alkaline soluble novolac resin and naphthoquinone diazide, naphthoquinone diazide is usually equal to or more than 15 weight part and is equal to or less than 30 weight part per 100 weight part of alkaline soluble novolac resin. As another example, in case of photoresist composed of combination of alkaline soluble polyhydroxy styrene resin and naphthoquinone diazide, naphthoquinone diazide is usually equal to or more than 20 weight part and is equal to or less than 50 weight part per 100 weight part of alkaline soluble polyhydroxy styrene resin. The esterification ratio of photoactive compound is preferred to be larger, preferably more than 90%.

By manufacturing the optical disc master as described above, resolution of photoresist necessary for high-density recording can be secured and therefore, a high-density recording optical disc excellent in signal quality can be manufactured with a high productivity.

Next, by changing the kind of photoresist and film thickness in various ways, specimens 1 to 15 were produced and evaluated and a result of that evaluation will be described below.

First, various kinds of photoresists were prepared as shown below.

A novolac resin was employed as a base resin and then, with a marketed product X (FH-EX3L2, made by FUJIFILM OLIN CO.,LTD.) as a base, which is a positive type photo resist containing 10 to 20 parts by weight of photoactive compound (naphthoquinone diazide) with respect to 100 weight part of base resin, the photoactive compound was increased by 20%, 50%, 80% so as to prepare photoresists 1 to 3. Then, the value A and value B of the marketed product X and photoresists 1 to 3 were measured under wavelength of 266 nm. Likewise, the value A and value B of a marketed product Y (DVR-100 made by NIPPON ZEON CO.,LTD.), which is another photoresist, were measured.

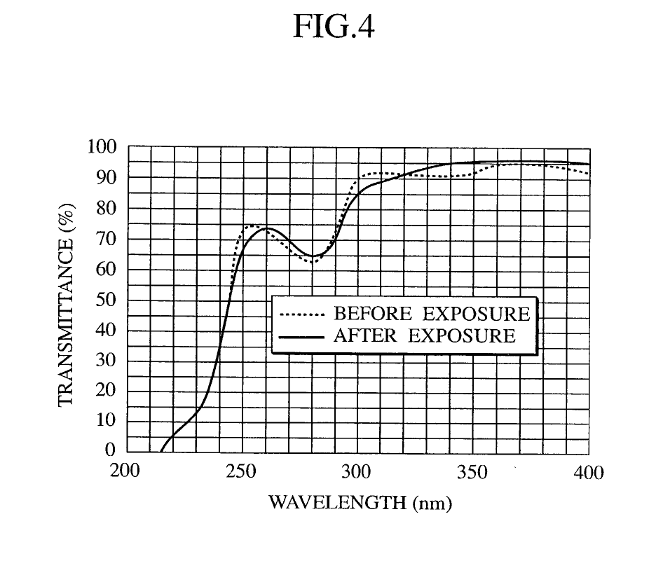

These value A and value B were obtained as follows: That is, first each photoresist was coated in an appropriate thickness. Then, spectral absorption spectrum before exposure was measured, and then after sufficient amount of ultraviolet ray was irradiated so as to decompose photoactive compound completely, absorption spectrum after exposure was measured. Then, the value A and value B were calculated according to the expressions (2) and (3) with transmittance T0 before exposure and transmittance T^{∞} after complete decomposition. FIG. 4 is a diagram showing an example of wavelength dependency of transmittance of the photoresist layer before and after exposure.

The result is shown as Table 1.

TABLE 1

| | Kind | value | value | Film | value A × | value B × | | |
|---|---|---|---|---|---|---|---|---|
| Speci- | of | A | B | thick- | film | film | | |
| men | photo- | (μ | (μ | ness | thick- | thick- | | Evalu- |
| No. | resist | m⁻¹) | m⁻¹) | (nm) | ness | ness | CN (dB) | tion |
| 1 | Photo- | 0.52 | 3.31 | 25 | 0.013 | 0.083 | 56.8 | X |
| 2 | resist | | | 50 | 0.026 | 0.165 | 60.1 | ◯ |
| 3 | 1 | | | 75 | 0.039 | 0.248 | 60.4 | ◯ |
| 4 | Photo- | 0.8 | 4.07 | 25 | 0.020 | 0.102 | 60.2 | ◯ |
| 5 | resist | | | 50 | 0.040 | 0.204 | 61.5 | ◯ |
| 6 | 2 | | | 75 | 0.060 | 0.300 | 60.4 | X |
| 7 | Photo- | 1.15 | 5.4 | 25 | 0.0288 | 0.135 | 61.2 | ◯ |
| 8 | resist | | | 50 | 0.0575 | 0.27 | 60.9 | ◯ |
| 9 | 3 | | | 75 | 0.0865 | 0.405 | 57.2 | X |
| 10 | Marke- | 0.26 | 2.81 | 25 | 0.0065 | 0.07 | 53.2 | X |
| 11 | ted | | | 50 | 0.013 | 0.141 | 54.1 | X |
| 12 | product | | | 75 | 0.0195 | 0.211 | 54.5 | X |
| | X | | | | | | | |
| 13 | Marke- | 1.20 | 6.15 | 25 | 0.030 | 0.154 | 60.1 | ◯ |
| 14 | ted | | | 50 | 0.060 | 0.308 | 57.1 | X |
| 15 | product | | | 75 | 0.090 | 0.461 | 55.1 | X |
| | Y | | | | | | | |

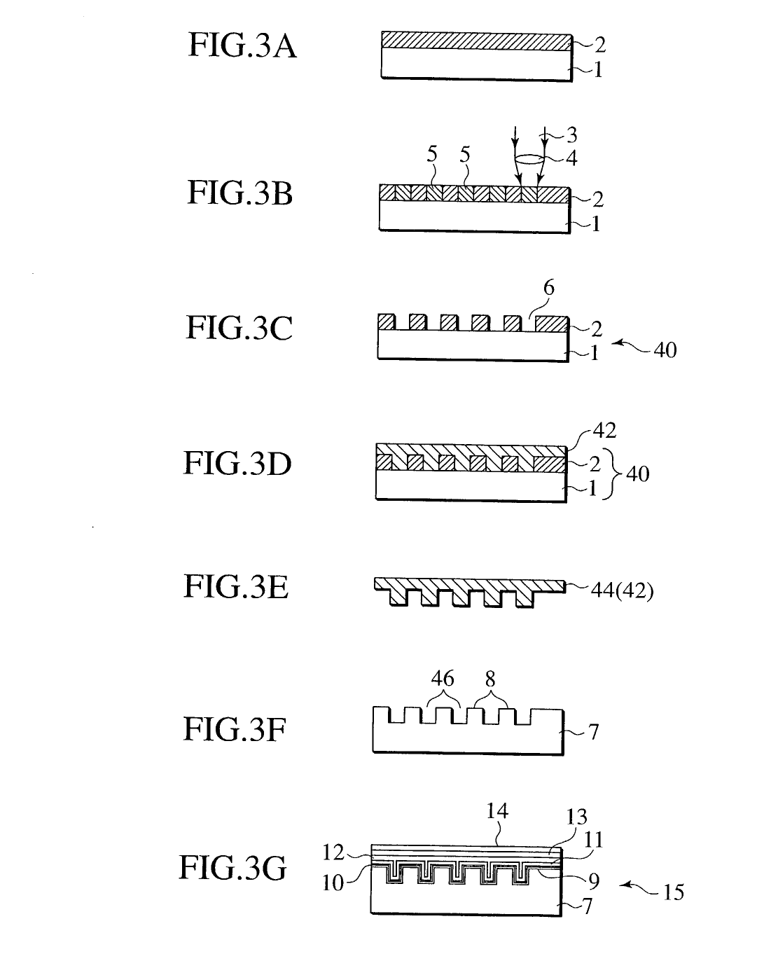

Next, an optical disc master was produced as shown in FIGS. 3A to 3G using various kinds of photoresists shown in Table 1. FIGS. 3A to 3G indicate process diagrams for explaining the first aspect of the present invention about the manufacturing method for the optical disc master.

First, by exposing a disc-like glass made substrate 1 ground precisely of 200 mm in diameter and 10 mm in thickness in vapor of hexamethyldisilazane for three minutes, the surface of this substrate 1 was provided with adhesive nature. Photoresist solution obtained by diluting various kinds of photoresists shown in Table 1 with solvent (PEGMEA) was uniformly applied according to spin-coating method and finally, that specimen was baked on a hot plate of 80° C. for 45 minutes in order to obtain a photoresist layer 2 (see FIG. 3A). For the photoresist layer 2, various kinds of film thickness shown in Table 1 were prepared by adjusting the dilution ratio of solvent and the spin revolution number.

Next, in order to record a continuous groove, the fourth harmonic generation YAG laser beam 3 of 266 nm in wavelength was focused through an objective lens 4 and this was irradiated on the photoresist layer 2 so as to form a latent image 5 (see FIG. 3B). Then, this photoresist layer 2 was developed using alkaline developer so as to dissolve an exposed area. Consequently, an optical disc master 40 having a continuous groove 6 having a track pitch of 0.32 μm was obtained (see FIG. 3C).

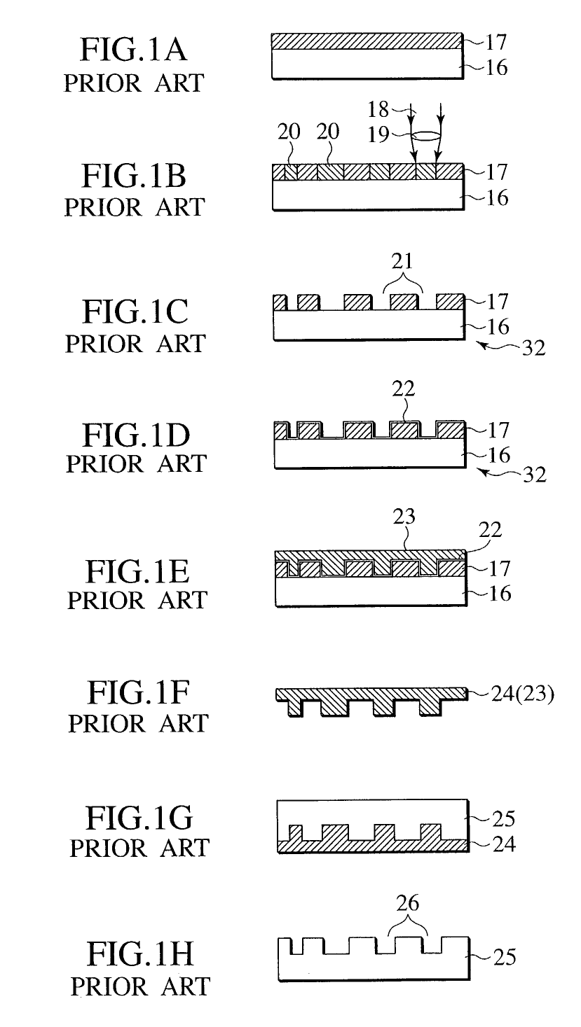

Next, in the same way as described in FIGS. 1D, 1E, conductive film of nickel or the like was formed on the surface of this optical disc master 40 by spattering or electroless plating and after that, nickel layer 42 was formed thickly by electric plating (see FIG. 3D). By separating this nickel layer 42 from the optical disc master 40, a metallic master including a signal pattern, namely, a stamper 44 was produced (see FIG. 3E).

Next, processing proceeds to manufacturing process of the optical disc.

First, a mold substrate 7 of 120 mm in diameter and 1.1 mm in thickness was produced with for example, the stamper 44 as a female mold according to compression method or the like in the same way as described in FIG. 1G (see FIG. 3F). At this time, a continuous groove 46 of 0.32 μm in track pitch is formed on the surface of this mold substrate 7 and a land portion 8 exists between the continuous grooves 46.

Next, an Al—Ti reflective layer 9 having the thickness of about 150 nm was formed on the surface having the continuous groove 46 of the produced mold substrate 7 by spattering method and then, second dielectric layer 10 (ZnS—SiO₂), phase change recording layer 11 (composition: Ag0.05—In0.05—Te0.30—Sb0.60), and first dielectric layer 12 (ZnS—SiO₂) were successively formed on the top of the reflective layer 9 by spattering. The film thickness of each is 20 nm for the second dielectric layer 10, 23 nm for the phase change recording layer 11 and 50 nm for the first dielectric layer 12. Then, by bonding, by spin coating method, a polycarbonate resin film 14 of 90 μm in thickness through the adhesive layer 13 to a surface in which the first dielectric layer 12 was formed, specimens 1 to 15 of recordable optical disc 15 were produced. In the meantime, an UV curable resin was used for the adhesive layer 13.

Laser beam is emitted from the side of the resin film 14 using a laser pickup having laser beam wavelength of 413 nm and lens NA of 0.8, and EFM signal having the minimum mark length of 0.15 μm is recorded. Table 1 shows a result of investigating the CN ratio when the recorded EFM signal is reproduced. Here, “x” and “O” in this evaluation indicate “not good” and “good” respectively.

Table 1 indicates that the CN ratio of specimens 2 to 5, 7, 8, 13, which were optical discs produced with the value obtained by multiplying the value A with the film thickness of photoresist set in a range of 0.02 to 0.06 and the value obtained by multiplying the value B with the film thickness set equal to or less than 0.3, was improved largely to substantially more than 60 dB thereby indicating a favorable characteristic. As described above, it has been testified that such a manufacturing method for the optical disc master is effective for manufacturing of a high-density optical disc.

As the material of the phase change recording layer, it is permissible to employ chalcogen base alloy such as GeSbTe, GeTe, GeTeS, GeSnTe, GeSnTeAu, GeSeS, GeSeAs, SbTe, SbSeTe, SeTe, SeAe, InTe, InSe, InSb, InSbSe, InSbTe, CuAlTeSb as well as the above-described materials.

It is permissible to use SiN, SiO, ZnS, ZnSSiO, AlO, MgF, InO, ZrO and the like as well as the aforementioned materials for the material of the dielectric layer.

The present invention can be applied to not only the phase change type recording disc but also a magneto-optical disc, additionally write-once disc and read-only disc.

Here, an example of the magneto-optical disc will be described.

Light reflecting film (AlTa), optical interfering film (SiN), magneto-optical recording film (NdFeCo) and optical interfering film (SiN) are formed successively on the surface of the side having the continuous groove of a mold substrate according to spattering method. Each film thickness is 80 nm for the light reflecting film, 80 nm for the optical interfering film and 90 nm for the magneto-optical film.

The specimens 1 to 15 were produced by bonding resin film in the same method as described above and evaluated in the same manner. Consequently, it was made evident that a favorable characteristic was acquired when the value obtained by multiplying the value A with the film thickness of photoresist was set in a range of 0.02 to 0.06 and the value obtained by multiplying the value B with the film thickness was set to be equal to or less than 0.3.

As material of the magneto-optical recording film, it is permissible to use an alloy of transition metal such as TbFeCo, GdFeCo, DyFeCo, TbCo, TbFe and rare earth metal or alternately overlaid film of cobalt and platinum. The transition metal may be replaced by Ho, Er, Yb, Lu. Also, Bi, Sn or the like may be added.

As material of the dielectric layer, it is permissible to use SiN, SiO, ZnS, ZnSSiO, AlO, MgF, InO, ZrO as well as the aforementioned materials.

Next, an example of the write-once disc will be described.

A light reflective film (AlTa) is formed on the surface of the side having the continuous groove of the mold substrate by spattering, and then a write-once recording film (cyanine base dye) is formed thereon by spin coating method. The thickness of the light reflective film was 70 nm and that of the write-once recording film was 120 nm.

Specimens 1 to 15 were produced by bonding resin films together in the same way as described above and evaluated in the same manner. Consequently, it has been made evident that a favorable characteristic can be obtained when the value obtained by multiplying the value A with the film thickness is set in a range of 0.02 to 0.06 and the value obtained by multiplying the value B with the film thickness is set to be equal to or less than 0.3.

Meanwhile, as material of the write-once recording film, it is permissible to use phthalocyanine dye, naphthalocyanine dye, azo dye, naphthoquinone dye as well as the aforementioned materials.

Next, an example of the read-only disc will be described.

Referring to FIGS. 3A to 3G, the EFM signal whose minimum pit length was 0.185 μm and track pitch was 0.32 μm was formed by exposure so as to produce a mold substrate. The light reflective film (AlTi) was formed on a surface in which a pit is formed of the mold substrate by spattering. The film thickness of the light reflective film was set to 60 nm.

Specimens 1 to 15 were produced by bonding resin films together in the same way as described above and evaluated in the same manner. Consequently, it has been made evident that a favorable characteristic can be obtained when the value obtained by multiplying the value A with the film thickness is set in a range of 0.02 to 0.06 and the value obtained by multiplying the value B with the film thickness is set to be equal to or less than 0.3.

As material of the read-only type light reflective material, it is permissible to use aluminum, gold, silver, copper, nickel, chrome, silicone, titan, tantalum or alloys composed of mainly any one of them or SiN, SiC, SiO, SiON, SiAlON or the like.

According to the first aspect of the present invention, even if a deep UV beam cutting is carried out using a conventional novolac-based photoresist at the time of manufacturing the optical disc master, a photoresist having resolution necessary for high-density recording can be acquired and therefore a high-density optical disc having an excellent signal quality can be manufactured at a high productivity.

Next, the second aspect of the present invention will be described.

This second aspect of the invention has been reached by finding out that a close relation exists between roughness of the surface of a non-exposed area of the photoresist layer and developing condition.

That is, in case where a novolac-based photoresist is cut with laser beam in a deep UV beam region having the wavelength of 200 to 300 nm as described above, the laser beam power needs to be increased because its sensitivity is not enough. However, if the laser beam power is increased, heat is generated by internal absorption of the photoresist, so that the photoresist layer is deformed by heat. As a result of considering a method for forming a pattern with laser beam power not producing thermal deformation, it has been made evident that developing with increased concentration of developer (normality of alkaline) is effective.

However, as described above, a disadvantage of increasing the concentration of developer is worsening of surface roughness. Thus, the present inventor considered the developing condition more precisely and consequently, he found out that the surface roughness could be reduced by setting up a condition for combination between the developing time and developer concentration.

According to the second aspect of the present invention, a photoresist layer is formed on a substrate and the photoresist layer is exposed to laser beam of 200 to 300 nm in wavelength so as to form a latent image corresponding to an information signal. The aforementioned latent image is developed with alkaline aqueous solution so as to form a convex-concave pattern. Further, according to the manufacturing method for the optical disc master, the normality of the alkaline aqueous solution is in a range of 0.2 to 0.35N, and a developing time is 10 to 60 seconds, and the alkaline aqueous solution is inorganic alkaline aqueous solution.

If the normality of the alkaline aqueous solution is smaller than 0.2N, the laser beam power needs to be increased for patterning and in this case, the photoresist layer is deformed by heat. Further, if the normality exceeds 0.35N, the surface roughness is increased under any developing time although patterning is possible. Further, as the alkaline aqueous solution, it is preferable to use inorganic alkaline aqueous solution.

Next, specimens 21 to 32 were produced by changing the kind and normality of alkaline aqueous solution and developing time for the photoresist layer and were evaluated. A result of the evaluation will be described below.

The manufacturing method for the optical disc master here will be described with reference to FIGS. 3A to 3G because it is basically equal to the method described according to FIGS. 3A to 3G.

First, by exposing a disc-like glass made substrate 1 ground precisely of 200 mm in diameter and 10 mm in thickness in vapor of hexamethyldisilazane for three minutes, the surface of this substrate 1 was provided with adhesive nature. Next, it was coated uniformly with novolac-based positive photoresist (THMR-iP3600, made by TOKYO OHKA KOGYO CO.,LTD.) diluted with solvent (PEGMEA) and finally, baked on a hot plate at 80° C. for 45 minutes, so that photoresist layer 2 having the film thickness of 25 nm was obtained (see FIG. 3A). As the novolac-based positive photoresist, three types, THMR-iP3100, THMR-iP3600, and TDMR-AR80 (made by TOKYO OHKA KOGYO CO.,LTD.) were used.

Next, in order to record a continuous groove, the fourth harmonic generation YAG laser beam 3 of 266 nm in wavelength was focused through an objective lens 4 and this was irradiated on the photoresist film 2 so as to form a latent image 5 (see FIG. 3B).

Then, alkaline developer has been used to develop the photoresist film 2 and an exposure is dissolved. As a result, an optical disc master 40 with a countinuous groove 6 of 0.32 μm in track pitch was obtained (see FIG. 3C).

At this time, some developing conditions were picked up with for example, developer type, normality and developing time set up as a parameter and an optical disc master corresponding to each condition was produced. More specifically, as the developer, inorganic alkaline solution or organic alkaline solution was used selectively and further, the normality (concentration) of this developer was changed or the developing time was changed in various ways.

Next, conductive film made of nickel or the like was formed on the surface of each optical disc master by spattering or electroless plating in the same way as described about FIGS. 1D, 1E and after that, nickel layer 42 is formed thickly by electric plating (see FIG. 3D). Then, a metallic master having a signal pattern or a stamper 44 was produced by separating this nickel layer 42 from the aforementioned optical disc master 40 (see FIG. 3E).

Next, processing proceeds to optical disc manufacturing process.

First, a mold substrate 7 of 120 mm in diameter and 1.1 mm in thickness was produced with for example, the stamper 44 as a female mold according to compression method or the like in the same way as described in FIG. 1G (see FIG. 3F). At this time, a continuous groove 46 of 0.32 μm in track pitch is formed on the surface of this mold substrate 7 and a land area 8 exists between the continuous grooves 46.

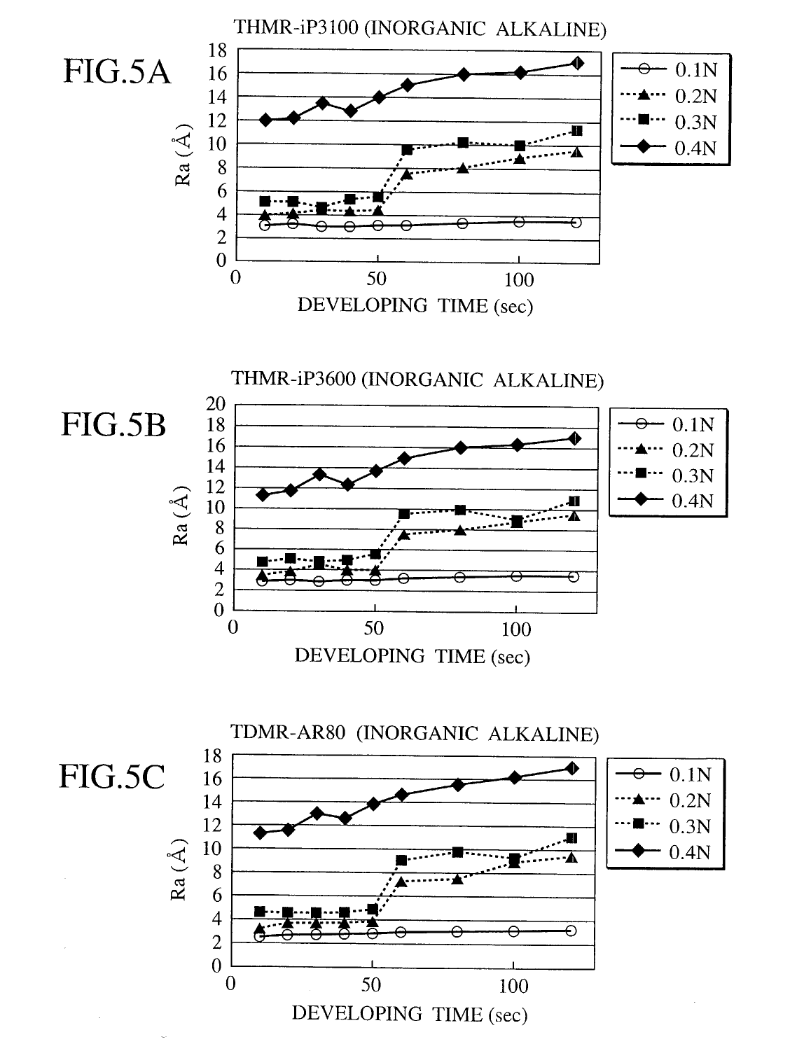

The surface roughness Ra of the land area 8 of each mold substrate 7 was measured with AFM (atomic force microscope). FIGS. 5A to 5C to FIGS. 7A to 7C show a result thereof. OFPR developer 3 was used for the inorganic alkaline developer indicated in the same Figure and NMD-3 (made by TOKYO OHKA KOGYO CO.,LTD.) was used for the organic alkaline developer indicated in the same Figure.

FIGS. 5A to 5C show a result of a case where while inorganic alkali was used as the developer, the normality N of the developer and developing time were changed.

It is made evident that any photoresist can suppress the surface roughness low even if the developing time is prolonged when the normality is 0.1N and that if the developing time is more than 60 sec, worsens the surface roughness when the normality is 0.2N or 0.3N. Therefore, it is evident that the upper limit of the developing time is 60 seconds. Then, if the normality is 0.4N, the surface roughness is increased regardless of the developing time. On the other hand, if the developing time is smaller than 10 seconds, the photoresist layer cannot be developed sufficiently.

If the normality is 0.1N, uniformity of the groove configuration is bad although the surface roughness is suppressed small. This reason may be that if the concentration of the developer is low, substantially the sensitivity drops, so that the laser beam power at the time of exposure needs to be increased and that if the laser beam power is increased, thermal deformation occurs due to the internal absorption of photoresist as described above.

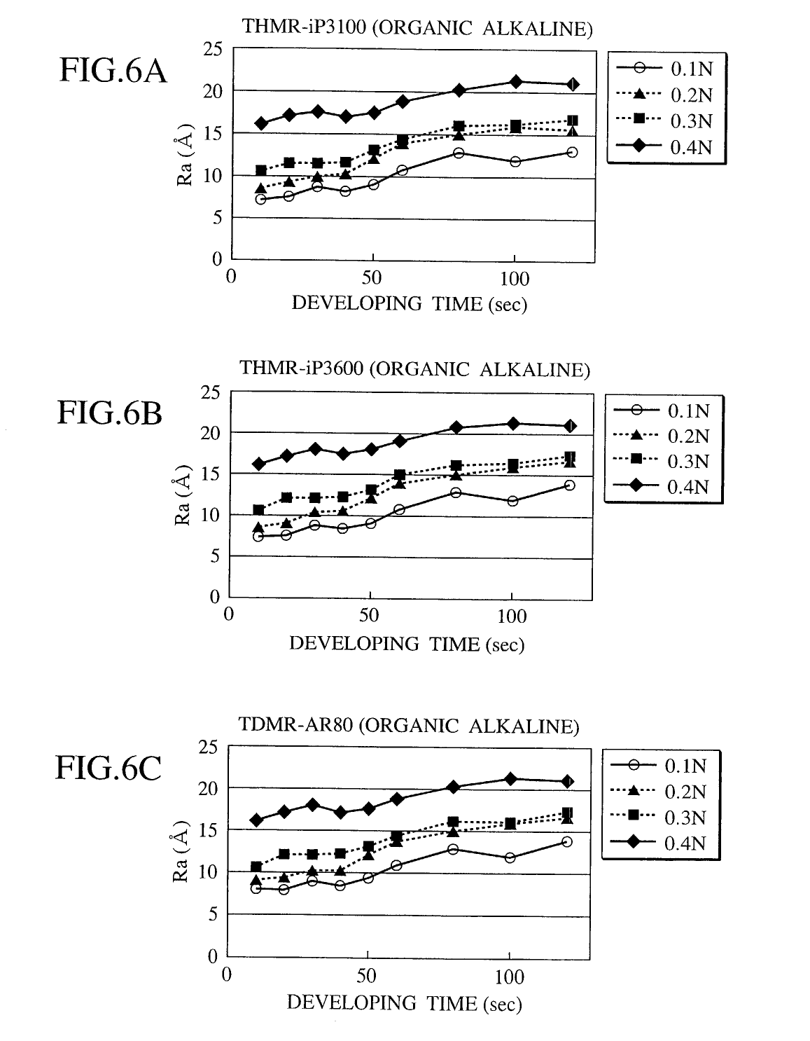

FIGS. 6A to 6C show a result of a case where while the organic alkali is used as the developer, the normality of the developer and the developing time were changed. In this case, the surface roughness was increased extremely more than the inorganic alkaline. Therefore, it is made evident that the inorganic alkaline was more preferable than the organic alkaline.

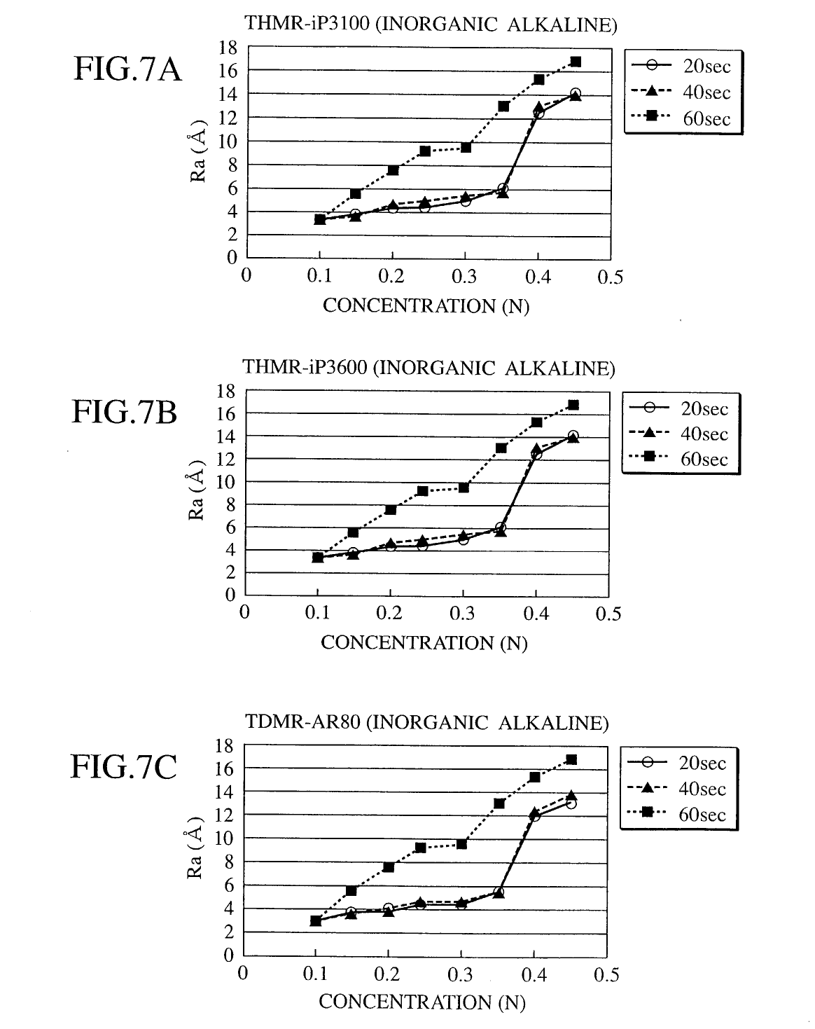

FIGS. 7A to 7C show the relation between the normality of the inorganic alkaline developer and the surface roughness. These Figures indicate that if the developing time is 20 seconds or 40 seconds, the surface roughness worsens rapidly when the normality of the developer rises over 0.35N. Therefore, it is made evident that the upper limit of the normality of the developer is 0.35N.

Next, the reflective layer 9 of AL—Ti having the thickness of about 150 nm was formed on the surface having the continuous groove 46 of the mold substrate 7 produced in the above-described manner by spattering and then, the second dielectric layer 10 (ZnS—SiO₂), the phase change recording layer (composition: Ag0.05—In0.05—Te0.30—Sb0.60) and the first dielectric layer 12 (ZnS—SiO₂) were formed successively on the reflective layer 9 by spattering. The film thickness is 20 nm for the second dielectric layer 10, 23 nm for the phase change recording layer 11 and 50 nm for the first dielectric layer 12. The polycarbonate resin film 14 of 90 μm was bonded by spin coating method to a surface in which the first dielectric layer 12 was formed through the adhesive layer 13 so as to produce specimens 21 to 32, which were recordable optical discs 15. In the meantime, UV curable resin was used for the adhesive layer 13.

Laser beam is emitted from the side of the resin film 14 using a laser pickup having laser beam wavelength of 413 nm and lens NA of 0.8, and EFM signal having the minimum mark length of 0.15 μm is recorded. Table 2 shows a result of investigating the CN ratio when the recorded EFM signal is reproduced. In the meantime, the THMR-iP3600 is employed for all the photoresists.

TABLE 2

| Speci- | | | | | | |
|---|---|---|---|---|---|---|
| men | Developer | Norm- | developing | Ra | CN | Evaluat- |
| No. | type | ality | time | (A) | (dB) | ion |
| 21 | inorganic | 0.1 | 20 | 3.1 | 48.2 | X |
| | alkali | | | | | |
| 22 | inorganic | 0.1 | 40 | 3.0 | 48.7 | X |
| | alkali | | | | | |
| 23 | inorganic | 0.1 | 60 | 3.1 | 48.1 | X |
| | alkali | | | | | |
| 24 | inorganic | 0.2 | 20 | 4.0 | 61.5 | ◯ |
| | alkali | | | | | |
| 25 | inorganic | 0.2 | 40 | 4.2 | 62.1 | ◯ |
| | alkali | | | | | |
| 26 | inorganic | 0.2 | 60 | 7.4 | 60.0 | ◯ |
| | alkali | | | | | |
| 27 | inorganic | 0.4 | 20 | 12.0 | 54.5 | X |
| | alkali | | | | | |
| 28 | inorganic | 0.4 | 40 | 12.6 | 54.6 | X |
| | alkali | | | | | |
| 29 | inorganic | 0.4 | 60 | 14.8 | 54.6 | X |
| | alkali | | | | | |
| 30 | organic | 0.2 | 20 | 9.3 | 55.8 | X |
| | alkali | | | | | |
| 31 | organic | 0.2 | 40 | 11.0 | 54.9 | X |
| | alkali | | | | | |
| 32 | organic | 0.2 | 60 | 14.3 | 54.1 | X |
| | alkali | | | | | |

<the THMR-iP3600 is used for all the photoresists>

“X” in this evaluation indicates “not good” while “O” indicates “good”. The CN ratio is good if it is 60 dB or more and the surface roughness Ra is good if it is less than 8 Å.

As evident from Table 2, the specimens 21 to 23 prepared with normality of developer 0.1N, which is smaller than 0.2N, have entirely poor characteristic because their CN ratio is smaller than 50 dB although the surface roughness Ra is 3 Å which is good. The specimens 27 to 29 prepared with the normality of the developer 0.4N, which is larger than 0.35N, have poor characteristic as a whole because the surface roughness Ra is more than 12 Å although the CN ratio is about 54 dB which is good.

Contrary to this, the characteristic of the specimens 30 to 32 which employ organic alkaline as their developer are not so high in terms of surface roughness Ra and CN ratio.

It is made evident that the specimens 24 to 26 prepared by using the inorganic alkaline as the developer with the normality thereof being 0.2N, which is in a range of 0.2 to 0.35N, have very excellent characteristic because the surface roughness Ra is sufficiently small while the CN ratio is around 60 dB.

Table 2 indicates that correlation exists between the surface roughness of the mold substrate and the CN ratio of a reproduction signal and it has been confirmed that it is effective to produce a mold substrate whose surface roughness is suppressed by adopting the developing condition of the present invention upon manufacturing of an optical disc master in order to improve the quality of the reproduction signal.

According to the second aspect of the present invention, even if a deep UV beam cutting is carried out using the conventional novolac-based photoresist at the time of manufacturing the optical disc master, the surface roughness of a non-exposed area can be reduced and therefore, a high-density optical disc having an excellent signal quality can be manufactured under a high productivity.

Same as described about the first aspect of the present invention, the second aspect of the invention can be applied to not only the phase change type recording disc, but also the magneto-optical disc, the write-once disc, and the read only disc.

As described above, according to the manufacturing method for the optical disc mater of the present invention, following excellent operation and effect can be exerted.

A photoresist having resolution necessary for high-density recording can be secured at the time of manufacturing the optical discmaster and the surface roughness of a non-exposed area can be reduced upon deep UV beam cutting of the photoresist. Therefore, a high-density optical disc having an excellent signal quality can be manufactured with a high productivity.

It should be understood that many modifications and adaptations of the invention will become apparent to those skilled in the art and it is intended to encompass such obvious modifications and changes in the scope of the claims appended hereto.

What is claimed is:

1. A manufacturing method for an optical disc master, in which a photoresist layer is formed on a substrate, and then a laser beam having a wavelength of 200 to 300 nm is exposed to the photoresist layer to form thereon a latent image corresponding to an information signal, and then the latent image is developed with an alkaline aqueous solution to form a convex-concave pattern, the method comprising the steps of:
setting a value obtained by multiplying a value A with a film thickness in a range of 0.02 to 0.06, the value A being a change amount of a light transmittance per unit depth under a wavelength of light for exposure of the photoresist layer; and
setting a value obtained by multiplying a value B with the film thickness to be equal to or less than 0.3, the value B being an optical density of a base resin and a photoproduct per unit depth under the wavelength of light for exposure of the photoresist layer.

2. A manufacturing method for an optical disc master, in which a photoresist layer is formed on a substrate, and then a laser beam having a wavelength of 200 to 300 nm is exposed to the photoresist layer to form thereon a latent image corresponding to an information signal, and then the latent image is developed with an alkaline aqueous solution to form a convex-concave pattern, the method comprising the steps of:
setting a normality of the alkaline aqueous solution in a range of 0.2 to 0.35N;
setting a developing time in a range of 10 to 60 seconds; and
selecting an inorganic alkaline aqueous solution as the alkaline aqueous solution.
